(19) United States
(12) Patent Application Publication
(10) Pub. No.: US 2018/0237265 A1
(43) Pub. Date: Aug. 23, 2018

(54) ELEVATOR ROPE TENSION ASSEMBLY WITH FRICTIONAL DAMPING

(71) Applicant: OTIS ELEVATOR COMPANY, Farmington, CT (US)

(72) Inventors: Richard N. Fargo, Plainville, CT (US); Randy Roberts, Hebon, CT (US)

(21) Appl. No.: 15/435,872

(22) Filed: Feb. 17, 2017

(51) Int. Cl. B66B 7/06; B66B 9/00

(52) U.S. Cl. CPC B66B 7/068; B66B 9/00; B66B 7/062

(57) ABSTRACT

An illustrative example elevator rope tensioning assembly includes a tensioning sheave configured to guide movement of a compensation rope. A tensioning mass is coupled with the tensioning sheave to provide weight urging the sheave in a tensioning direction. A rail structure guides vertical movement of the tensioning mass. A frictional damper continuously resists vertical movement of the tensioning mass.

### BACKGROUND

Elevator systems are sometimes configured as traction-based systems in which a roping arrangement supports the weight of the elevator car and a counterweight. A traction sheave controls movement of the roping arrangement to control movement of the elevator car. Various tensioning arrangements have been developed to ensure appropriate tension on the roping arrangement to achieve consistent elevator system operation, for example. Some tensioning arrangements include a compensation chain. Others include a compensation rope. For systems with a compensation rope, a compensation sheave and mass may be included to guide movement of the compensation rope and to assist in ensuring appropriate tension in the traction-based system.

For higher speed elevator systems, an additional hardware arrangement for so-called tie down compensation allows for addressing dynamic events in the elevator system during car movement. Even with such tie down hardware, a possibility exists for the elevator car to oscillate or bounce up and down at a landing while the load on the car changes with passengers entering or exiting the car. This condition is even more likely to occur when the elevator car is at one of the lower landings along the hoistway. It would be useful to be able to eliminate or reduce such elevator car movement at a landing.

### SUMMARY

An illustrative example elevator rope tensioning assembly, includes a tensioning sheave configured to guide movement of a compensation rope, a tensioning mass coupled with the tensioning sheave to provide weight urging the sheave in a tensioning direction, a rail structure that guides vertical movement of the tensioning mass, and a frictional damper that continuously resists vertical movement of the tensioning mass.

In an example embodiment having one or more features of the assembly of the previous paragraph, the frictional damper comprises at least one friction surface situated to contact a stationary surface in a manner that friction between the friction surface and the stationary surface provides resistance to the vertical movement of the tensioning mass.

In an example embodiment having one or more features of the assembly of any of the previous paragraphs, the stationary surface is on the rail structure.

In an example embodiment having one or more features of the assembly of any of the previous paragraphs, the frictional damper comprises an arm connected with the tensioning mass near a first end of the arm, and the friction surface is supported on the arm near a second, opposite end of the arm.

In an example embodiment having one or more features of the assembly of any of the previous paragraphs, the rail structure includes at least one vertically oriented rail that facilitates vertical movement of the tensioning mass, the tensioning mass includes at least one rail guide, and the frictional damper is supported on the at least one rail guide to frictionally engage the at least one vertically oriented rail.

An illustrative example method of providing tension for an elevator rope that suspends an elevator car and a counterweight, includes coupling a compensation rope to the elevator car and the counterweight; wrapping the compensation rope about a tensioning sheave, coupling a tensioning mass to the tensioning sheave for urging the tensioning sheave in a tensioning direction, and using friction for continuously resisting vertical movement of the tensioning mass.

In an example embodiment having one or more features of the method of the previous paragraph, using friction for continuously resisting the vertical movement of the tensioning mass comprises situating a friction surface of a frictional damper to contact a stationary surface in a manner that friction between the friction surface and the stationary surface provides resistance to the vertical movement of the tensioning mass.

In an example embodiment having one or more features of the method of any of the previous paragraphs, the stationary surface is on a rail structure that guides vertical movement of the tensioning mass.

In an example embodiment having one or more features of the method of any of the previous paragraphs, the frictional damper comprises an arm connected with the tensioning mass near a first end of the arm and the friction surface is supported on the arm near a second, opposite end of the arm.

In an example embodiment having one or more features of the method of any of the previous paragraphs, there is at least one vertically oriented rail that facilitates vertical movement of the tensioning mass, the tensioning mass includes at least one rail guide, and using friction for continuously resisting vertical movement of the tensioning mass includes supporting a friction surface on the at least one rail guide to frictionally engage the at least one vertically oriented rail.

An illustrative example embodiment of an elevator system includes an elevator car, a counterweight, a load bearing assembly coupling the elevator car and the counterweight, a traction sheave that selectively causes movement of the load bearing assembly to control movement of the elevator car, a compensation rope coupled to the elevator car and the counterweight, a tensioning sheave, the compensation rope being wrapped about the tensioning sheave to guide movement of the compensation rope, a tensioning mass coupled with the tensioning sheave to provide weight urging the tensioning sheave in a tensioning direction, a rail structure that guides vertical movement of the tensioning mass, and a frictional damper that continuously resists vertical movement of the tensioning mass.

In an example embodiment having one or more features of the system of the previous paragraph, the frictional damper comprises at least one friction surface situated to contact a stationary surface of the elevator system in a manner that friction between the friction surface and the stationary surface provides resistance to the vertical movement of the tensioning mass.

In an example embodiment having one or more features of the system of any of the previous paragraphs, the stationary surface is on the rail structure.

In an example embodiment having one or more features of the system of any of the previous paragraphs, the frictional damper comprises an arm connected with the tensioning mass near a first end of the arm and the friction surface is supported on the arm near a second, opposite end of the arm.

In an example embodiment having one or more features of the system of any of the previous paragraphs, the rail structure includes at least one vertically oriented rail that facilitates vertical movement of the tensioning mass, the tensioning mass includes at least one rail guide, and the frictional damper is supported on the at least one rail guide to frictionally engage the at least one rail.

In an example embodiment having one or more features of the system of any of the previous paragraphs, the load bearing assembly includes a plurality of round ropes.

In an example embodiment having one or more features of the system of any of the previous paragraphs, the load bearing assembly includes a plurality of flat belts.

Various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system including a rope tensioning assembly designed according to an embodiment of this invention.

FIG. 2 schematically illustrates selected portions of a frictional damper arrangement designed according to an embodiment of this invention.

FIG. 3 schematically illustrates selected features of another frictional damper arrangement.

### DETAILED DESCRIPTION

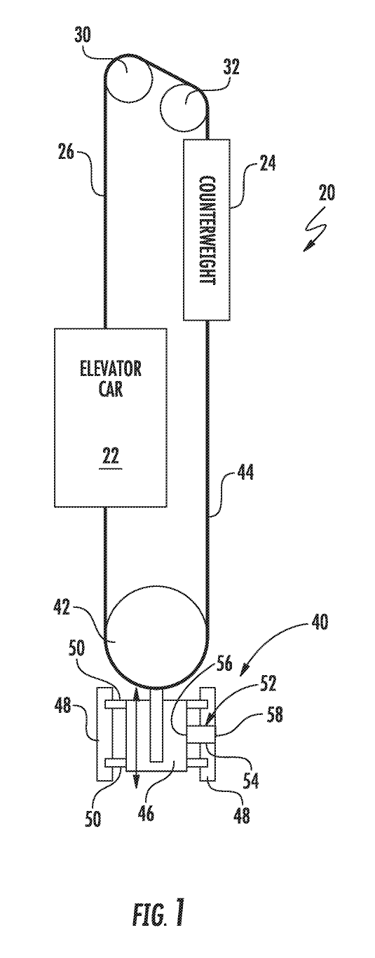

FIG. 1 schematically illustrates an elevator system 20 including an elevator car 22 and counterweight 24. A load bearing assembly 26 couples the elevator car 22 to the counterweight 24. The roping ratio and component arrangement are for illustration and discussion purposes only. A variety of elevator system configurations may incorporate one or more embodiments of this invention.

The load bearing assembly 26 in some examples comprises a plurality of round steel ropes. In other examples, the load bearing assembly 26 comprises a plurality of flat belts. Other types of roping arrangements may be utilized as the load bearing assembly 26. The term “rope” as used in this document should not be interpreted in its strictest sense. A “rope” may comprise, for example, a belt and may have various configurations.

A traction sheave 30 operates in a known manner to control movement of the load bearing assembly 26. When appropriate traction exists between the traction sheave 30 and the load bearing assembly 26, appropriate control is maintained over the movement of the elevator car 22. The illustrated example includes an idler or deflector sheave 32. A variety of roping arrangements, such as those known in the art, may be utilized. The illustration is for discussion purposes and those skilled in the art will appreciate that many other components of an elevator system would be included in an actual implementation.

The elevator system 20 includes a rope tensioning assembly 40 to ensure appropriate tension on the load bearing assembly 26, which facilitates more consistent and reliable elevator system operation for known reasons. The rope tensioning assembly 40 includes a tensioning sheave 42 that guides movement of a compensation rope 44. In this example, the compensation rope 44 is coupled to the elevator car 22 and the counterweight 24. A tensioning mass 46 is coupled to the tensioning sheave 42 to urge the tensioning sheave in a tensioning direction. According to the example of FIG. 1, the mass 46 is pulled downward by gravity to urge the tensioning sheave 42 in a downward direction for applying tension to the compensation rope 44.

The tensioning assembly 40 includes a rail structure 48 having at least one vertically oriented rail for facilitating vertical movement of the mass 46. In the illustrated example, the mass 46 and the tensioning sheave 42 are effectively suspended by the compensation rope 44. The mass 46 has a plurality of rail guides 50 that move along vertically oriented rail portions of the rail structure 48 for guiding vertical movement of the mass 46 and the associated tensioning sheave 42. In some embodiments, the rail guides are included as part of the rail structure 48 and the rails are secured to the mass 46.

A frictional damper 52 is associated with the mass 46 to frictionally resist vertical movement of the tensioning mass 46. The frictional damper 52 is arranged to continuously resist vertical movement of the tensioning mass 46. The frictional damper 52 resists vertical movement of the tensioning mass 46 in both directions (i.e., upward and downward).

One aspect of the frictional damper 52 that differs from tie down hardware associated with some elevator systems is that tie down hardware is only employed under certain elevator operating conditions. The frictional damper 52 continuously applies frictional resistance to any vertical movement of the tensioning mass 46 under all elevator operating conditions. Tie down hardware is typically only useful for addressing dynamic events and is typically not capable of addressing a situation where the elevator car is at a landing and oscillating or bouncing up and down responsive to changing loads on the car. The frictional damper 52, on the other hand, is particularly configured for resisting such elevator car movement while the car is at a landing.

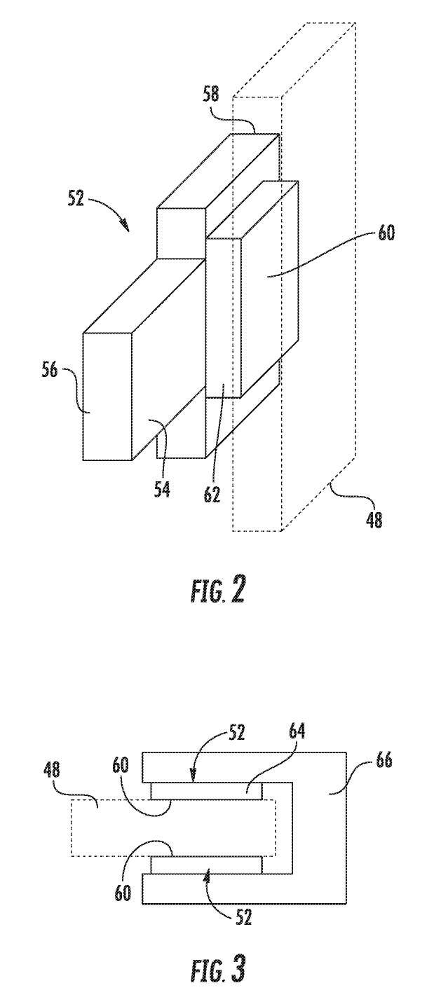

The frictional damper 52 may take a variety of forms. One example embodiment is shown in FIG. 2 in which the frictional damper 52 includes an arm 54 that is connected with the tensioning mass 46 near a first end 56 of the arm 54. A second, opposite end 58 of the arm 54 supports a friction member, which in this example comprises a friction surface 60 on a pad 62. In some examples, the pad 62 comprises a known brake pad material. The arm 54 and the pad 62 are situated so that the friction surface 60 engages a portion of the rail structure 48. In some examples, the friction surface 60 engages a stationary surface in the elevator hoistway that is separate from the rail structure 48.

FIG. 3 schematically illustrates another example embodiment in which the tensioning mass 46 has an associated rail follower 66 that is configured to follow along a rail portion of the rail structure 48 that guides vertical movement of the tensioning mass 46. In this example, the rail guide 66 supports friction pads 64 having friction surfaces 60 received against the rail portion of the rail structure 48.

With either of the example configurations, the friction surface 60 engages another surface, which is stationary or otherwise stable, to continuously provide frictional resistance to vertical movement of the tensioning mass 46 under all elevator system operating conditions, including those in which the elevator car is parked at a landing. In some embodiments, additional tie down hardware is provided to address dynamic events in the elevator system when required by code, for example, because the elevator system operates at relatively higher speeds.

During most elevator system operating conditions the tensioning mass 46 tends to remain stationary so the frictional damper 52 does not introduce any significant wear and there is no need for a mechanism to activate or deactivate the damper 52. Instead, the frictional damper 52 is continuously operational to resist vertical movement of the tensioning mass 46 without requiring any actuator or control components.

The example rope tensioning assembly provides a quiet, inexpensive, and reliable solution to problems otherwise associated with elevator roping sag and undesired car movement at a landing.

The preceding description is exemplary and illustrative in nature rather than being limiting. Variations and modifications to the disclosed example embodiments may become apparent to those skilled in the art that do not necessarily depart from the essence of the invention. The scope of protection provided to the invention can only be determined by studying the following claims.

We claim:

1. An elevator rope tensioning assembly, comprising:
a tensioning sheave configured to guide movement of a compensation rope;
a tensioning mass coupled with the tensioning sheave to provide weight urging the sheave in a tensioning direction;
a rail structure that guides vertical movement of the tensioning mass; and
a frictional damper that continuously resists vertical movement of the tensioning mass.

2. The assembly of claim 1, wherein the frictional damper comprises at least one friction surface situated to contact a stationary surface in a manner that friction between the friction surface and the stationary surface provides resistance to the vertical movement of the tensioning mass.

3. The assembly of claim 2, wherein the stationary surface is on the rail structure.

4. The assembly of claim 2, wherein
the frictional damper comprises an arm connected with the tensioning mass near a first end of the arm; and
the friction surface is supported on the arm near a second, opposite end of the arm.

5. The assembly of claim 1, wherein
the rail structure includes at least one vertically oriented rail that facilitates vertical movement of the tensioning mass;
the tensioning mass includes at least one rail guide; and
the frictional damper is supported on the at least one rail guide to frictionally engage the at least one vertically oriented rail.

6. A method of providing tension for an elevator rope that suspends an elevator car and a counterweight, the method comprising:
coupling a compensation rope to the elevator car and the counterweight;
wrapping the compensation rope about a tensioning sheave;
coupling a tensioning mass to the tensioning sheave for urging the tensioning sheave in a tensioning direction; and
using friction for continuously resisting vertical movement of the tensioning mass.

7. The method of claim 6, wherein using friction for continuously resisting the vertical movement of the tensioning mass comprises situating a friction surface of a frictional damper to contact a stationary surface in a manner that friction between the friction surface and the stationary surface provides resistance to the vertical movement of the tensioning mass.

8. The method of claim 7, wherein the stationary surface is on a rail structure that guides vertical movement of the tensioning mass.

9. The method of claim 7, wherein
the frictional damper comprises an arm connected with the tensioning mass near a first end of the arm; and
the friction surface is supported on the arm near a second, opposite end of the arm.

10. The method of claim 6, wherein
there is at least one vertically oriented rail that facilitates vertical movement of the tensioning mass;
the tensioning mass includes at least one rail guide; and
using friction for continuously resisting vertical movement of the tensioning mass includes supporting a friction surface on the at least one rail guide to frictionally engage the at least one vertically oriented rail.

11. An elevator system, comprising:
an elevator car;
a counterweight;
a load bearing assembly coupling the elevator car and the counterweight;
a traction sheave that selectively causes movement of the load bearing assembly to control movement of the elevator car;
a compensation rope coupled to the elevator car and the counterweight;
a tensioning sheave, the compensation rope being wrapped about the tensioning sheave to guide movement of the compensation rope;
a tensioning mass coupled with the tensioning sheave to provide weight urging the tensioning sheave in a tensioning direction;
a rail structure that guides vertical movement of the tensioning mass; and
a frictional damper that continuously resists vertical movement of the tensioning mass.

12. The elevator system of claim 11, wherein the frictional damper comprises at least one friction surface situated to contact a stationary surface of the elevator system in a manner that friction between the friction surface and the stationary surface provides resistance to the vertical movement of the tensioning mass.

13. The elevator system of claim 12, wherein the stationary surface is on the rail structure.

14. The elevator system of claim 12, wherein
the frictional damper comprises an arm connected with the tensioning mass near a first end of the arm; and
the friction surface is supported on the arm near a second, opposite end of the arm.

15. The elevator system of claim 11, wherein
the rail structure includes at least one vertically oriented rail that facilitates vertical movement of the tensioning mass;
the tensioning mass includes at least one rail guide; and
the frictional damper is supported on the at least one rail guide to frictionally engage the at least one rail.

16. The elevator system of claim 11, wherein the load bearing assembly includes a plurality of round ropes.

17. The elevator system of claim 11, wherein the load bearing assembly includes a plurality of flat belts.
